(19) United States
(12) Patent Application Publication
(10) Pub. No.: US 2014/0340687 A1
(43) Pub. Date: Nov. 20, 2014

(54) GYROLASER WITH OPTIMIZED IGNITION

(71) Applicant: THALES, NEUILLY SUR SEINE (FR)

(72) Inventors: Selvin DAVID, CHATELLERAULT (FR); Olivier CHAZALMARTIN, SAINT GEORGES-LES-BAILLARGEAUX (FR); Alexandre MARY, CHATELLERAULT (FR)

(21) Appl. No.: 14/254,739

(22) Filed: Apr. 16, 2014

(30) Foreign Application Priority Data
Apr. 19, 2013 (FR) 1300927

(51) Int. Cl. G01C 19/66

(52) U.S. Cl. CPC G01C 19/661
USPC 356/459

(57) ABSTRACT

A gyrolaser comprises: a ring-shaped optical cavity and a gaseous medium, and at least three electrodes in contact with the gas of the amplification medium, the electrodes generating charges when ignition voltage is applied; the cavity and distribution of the electrodes comprising at least one plane of symmetry perpendicular to the plane of the cavity and passing through the electrode of first type; at least one conductive ignition element set at a predetermined potential, the shape and arrangement being such that symmetry is maintained; the electrically conductive element generating an electric field locally for guiding the charges so they are distributed symmetrically in a first flow and second flow in the first and second discharge areas respectively when the ignition voltage is applied, in such a way that a first plasma and a second plasma are initiated simultaneously, respectively, in the first discharge area and in the second discharge area.

### CROSS-REFERENCE TO RELATED APPLICATION

This application claims priority to foreign French patent application No. FR 1300927, filed on Apr. 19, 2013, the disclosure of which is incorporated by reference in its entirety.

### FIELD OF THE INVENTION

The present invention relates to the field of rate gyros using the laser effect, called gyrolasers, used notably in inertial navigation systems required for the navigation of certain types of vehicle such as aircraft.

### BACKGROUND

A known gyrolaser, as shown in FIG. 1, is a bidirectional ring laser which can be used to measure an angular velocity (or a relative angular position by time integration). It is composed of a resonant optical cavity, typically triangular (FIG. 1) or square, the vertices of which are formed by mirrors (M1, M2 and M3 in FIG. 1), assembled on a block 101 in which paths are drilled to provide the optical cavity. In order to minimize its thermal expansion, the block 101 is made of glass ceramic material, typically Zerodur (registered trademark). A gaseous medium 102 is present in the optical path of the cavity and at least one portion of the latter forms the amplification medium in which the population inversion takes place. An excitation system supplies energy to the gyrolaser to generate the laser gain. The components of the laser cavity are chosen so as to allow bidirectional operation: the laser cavity must be able to simultaneously support two waves propagating in opposite directions (called counter-rotating waves).

The operating principle of a gyrolaser is based on the Sagnac effect in a ring laser cavity to which a rotary movement is imparted. When the cavity is stationary, the two counter-rotating waves have the same optical frequency. If a rotary movement is present in the plane of the optical cavity, the Sagnac effect creates a frequency difference between the two counter-rotating optical waves. A fraction of the energy of each wave is extracted from the cavity by a partially transmissive mirror M2. A recombination device, for example a prism P, causes the two extracted beams to interfere, forming interference fringes which are observed by means of one or more photodetectors. The frequency of the fringes across the photodetector is proportional to the rotation speed established in the cavity, and their direction of shift depends on the direction of rotation.

FIG. 1 shows a triangular single-axis gyrolaser, sensitive on a single axis of rotation, which uses an amplification medium consisting of a portion of the gaseous medium 102, which is usually a mixture of helium and neon. A population inversion is established in the amplification medium by generating a plasma (amplification medium).

This plasma is produced by applying a voltage between two electrodes, namely an anode and a cathode, fixed mechanically to the cavity and immersed in the gas. The application of a high voltage, called the ignition voltage, typically in the form of a pulse of several kilovolts for a period of 1 μs to several ms, between the two electrodes ionizes the portion of gaseous medium, called the discharge area, located between these electrodes, and makes it conducting (electrical discharge), thus generating the gaseous plasma. The application of a lower voltage (typically several hundred volts) establishes a current. The circulating electrons surrender their kinetic energy to the atoms of the gaseous medium, causing the desired population inversion.

If there are only two electrodes and only one amplification medium between them, with a single flow of electrons from the cathode towards the anode, one optical wave is propagated in the same direction as the electrons, while the other wave is propagated in the opposite direction. These optical waves propagated in the cavity interact with the electrical charges of the gaseous plasma, and this asymmetry of interaction creates an excessive “false zero” in the gyrolaser.

One solution is to make the electron fluid flow symmetrical with respect to the counter-rotating waves. For this purpose, the gyrolaser comprises one electrode of a first type (anode or cathode) and at least two electrodes of a second type (cathode or anode). In FIG. 1, the gyrolaser comprises a cathode electrode C and two anode electrodes A1 and A2. By simultaneously applying a ignition voltage between C and A1, forming a first discharge area Z1, and between C and A2, forming a second discharge area Z2, two flows of ionized charges (electrons in FIG. 1) F1 and F2 are generated in the first area Z1 and the second area Z2 respectively, enabling two plasmas P1 and P2 to be established in the first area Z1 and the second area Z2 respectively. The plasmas P1 and P2 are shown schematically in FIG. 1 by hatching. The total sum of the flows through which each optical wave passes is then identical. Additionally, to enable the gyrolaser to operate, both the optical cavity and the distribution of the electrodes C, A1 and A2 must have a plane of symmetry xz, the axis x being located in the plane of the cavity and passing through the single cathode, while the axis z is perpendicular to the plane of the cavity. The symmetry of the discharges makes it possible to compensate for the Fizeau effects on the two counter-propagating beams.

Known gyrolasers such as those shown in FIG. 1 have, notably, a drawback in that, if the ignition of the two areas Z1 and Z2 is not perfectly symmetrical, short-circuit or incorrect ignition phenomena occur, as shown in FIG. 2A or 2B. In this case, the rate gyro function cannot be maintained, for the aforementioned reasons, the electronic circuit cuts the power supply, and the gyrolaser stops automatically. Generally, it is then necessary to wait for several minutes to discharge the residual charges in the plasma before reignition can be attempted with a good chance of success. In aeronautical applications, this situation is unacceptable. It is therefore absolutely essential to ensure correct and reliable ignition of the gyrolaser.

Asymmetrical ignition can be caused, for example, by two phenomena. FIG. 2A shows the case in which ignition failed to take place in the second ignition area Z2 (non-start). The ignition voltage applied between the cathode C and the anode A2 did not enable a plasma discharge to be generated. A single discharge, corresponding to the charge flow F1 only, generated a plasma P1, and therefore only one amplification medium was obtained between the cathode C and the anode A1 after the ignition phase.

FIG. 2B shows the case in which bridging has occurred: the plasma discharge, and therefore the charge flow FP, is asymmetrical, with the charges flowing between the cathode C and the anode A2, bypassing the anode A1. The anode A1 in FIG. 2B is short-circuited. The amplification medium extends in the portion of gas between C and A1 (Z1) and between A1 and A2, passing the vertex of the triangle opposite the cathode C.

Another challenge at the present time is to reduce the size of gyrolasers, which currently have dimensions of one to several tens of cm (the beam path lengths are typically in the range from 8 to 40 cm), while maintaining performance and service life. The size of the Zerodur block has therefore been reduced, but the size of the electrodes cannot be reduced to the same degree (except with a diminished service life). The compactness of the gyrolaser therefore increases the risks of bridging and non-start.

The object of the present invention is to overcome the aforementioned drawbacks. In particular, the object of the present invention is to provide a gyrolaser having correct and reliable ignition.

### SUMMARY OF THE INVENTION

More precisely, the invention proposes a gyrolaser comprising:
at least one ring-shaped optical cavity and a gaseous medium, at least a portion of which forms an amplification medium, the cavity and the amplification medium being contained in a block and being such that two optical modes, called counter-rotating, can be propagated in opposite directions to each other within the optical cavity,
at least three electrodes in contact with the gas of the amplification medium, namely at least one electrode of a first type and at least a first electrode of a second type and a second electrode of a second type, the electrodes being adapted to generate charges in a portion of gaseous medium located between the electrode of a first type and the first electrode of the second type, called the first discharge area, and in a portion of gas located between the electrode of a first type and the second electrode of the second type, called the second discharge area, when an electrical ignition voltage is applied, respectively, between the electrode of a first type and the first electrode of the second type, and between the electrode of a first type and the second electrode of the second type, the cavity and a distribution of the electrodes comprising at least one plane of symmetry perpendicular to the plane of the cavity,
at least one electrically conductive ignition element set at a predetermined potential, and having a shape and arrangement such that symmetry is maintained, the electrically conductive element being adapted to generate an electric field locally for guiding the charges so that they are distributed symmetrically in a first flow and a second flow in the first and second discharge areas respectively when said ignition voltage is applied, in such a way that a first plasma and a second plasma are initiated simultaneously, respectively, in the first discharge area and in the second discharge area, the electrically conductive element being placed in the proximity of a discharge-free area and providing guidance by repulsion of charges out of an area which does not form a discharge area.

Advantageously, the gyrolaser further comprises an additional conductive element comprising at least one part extending along the charge path in the plasma discharge areas and providing guidance by attracting charges into the areas, and at least one conductive element placed in the proximity of a discharge-free area and providing guidance by repulsion of charges out of an area which does not form a discharge area.

Advantageously, the electrode of the first type is a cathode and the electrodes of the second type are anodes.

According to one embodiment, at least one conductive element is electrically connected to an electrode.

According to one embodiment, at least one conductive element is strip-shaped.

According to another embodiment, at least one conductive element is pad-shaped.

According to one embodiment, at least one conductive element is placed on the surface of said block.

According to another embodiment, at least one conductive element is placed at least partially within a cavity of said block.

### BRIEF DESCRIPTION OF DRAWINGS

Other characteristics, objects and advantages of the present invention will be made clear by the following detailed description, with reference to the attached drawings provided as non-limiting examples, in which:

FIG. 1, mentioned above, shows the structure of a gyrolaser according to the prior art.

FIGS. 2A and 2B, mentioned above, shows two cases of incorrect ignition of the gyrolaser according to the prior art.

FIG. 3 shows a gyrolaser according to the invention.

FIG. 4 shows an embodiment of a gyrolaser according to the invention comprising two additional conductive elements.

FIG. 5 shows the electrical fields present at ignition for a gyrolaser according to the prior art.

FIG. 6 shows another variant of the gyrolaser according to the invention.

FIG. 7 shows another variant of the gyrolaser according to the invention.

FIG. 8 shows an embodiment of the conductive element according to the invention.

FIG. 9 shows another embodiment of the conductive element according to the invention.

FIG. 10 shows another embodiment of the conductive element according to the invention.

### DETAILED DESCRIPTION

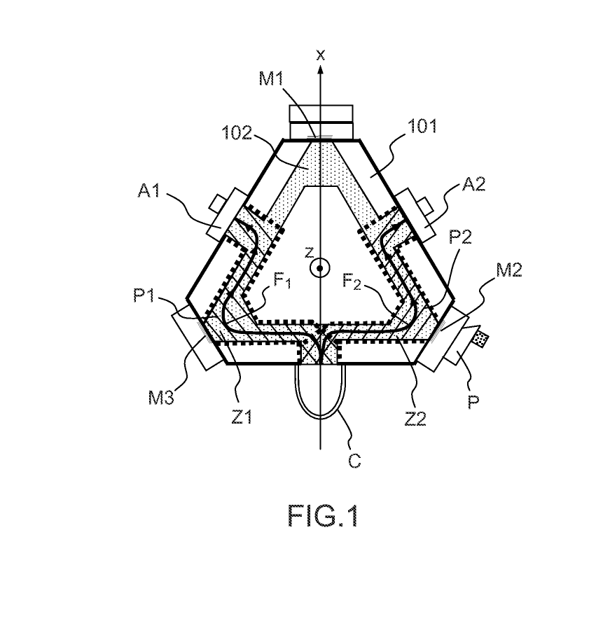

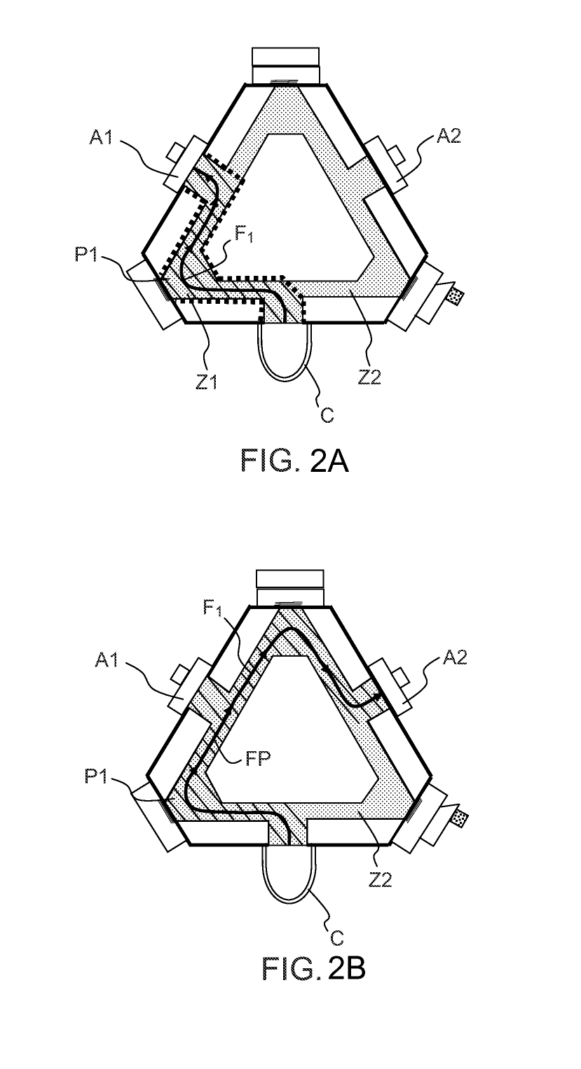

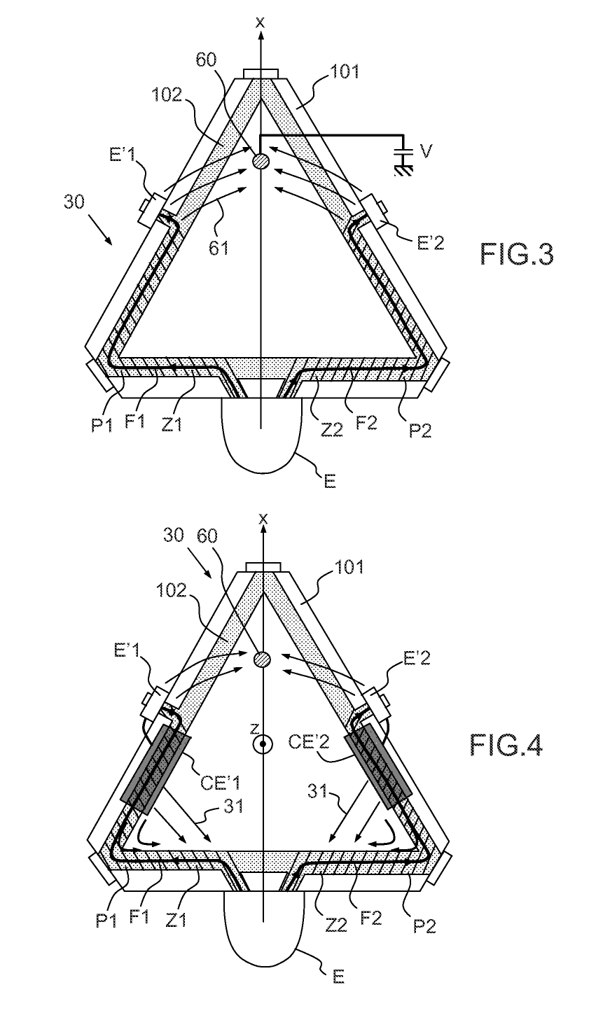

FIG. 3 shows a gyrolaser 30 according to the invention. This gyrolaser has the same characteristics and mode of operation as a prior art gyrolaser of the single axis type, as shown in FIG. 1. It comprises a ring-shaped optical cavity and a gaseous medium 102, at least a portion of which forms an amplification medium for a laser. The optical cavity and the amplification medium placed on the optical path of the laser beam are contained in a block 101. This block is made, for example, from glass ceramic, a material well known for its low coefficient of expansion as a function of temperature. Two optical modes, called counter-rotating, can be propagated in opposite directions to each other within the optical cavity.

The gyrolaser according to the invention comprises at least three electrodes in contact with the gas of the amplification medium, namely at least one electrode E of a first type and at least two electrodes E′1 and E′2 of a second type, called the first electrode and second electrode respectively.

In a preferred variant, the electrode E is a cathode C and the electrodes E′1 and E′2 are two anodes A′1 and A′2. The potential applied to the cathode is lower than the potential applied to the anodes, and the negative charges (electrons) of the ionized gas flow from the cathode towards the anodes. However, the invention is equally applicable to a gyrolaser comprising two cathodes and one anode.

When the gyrolaser 30 is started, the ignition voltage is applied simultaneously between, on the one hand, the electrode of a first type E and the first electrode of the second type E′1, and, on the other hand, between the electrode E and the second electrode of the second type E′2. According to the ignition principle described above, the live electrodes generate charges, for example electrons with a negative charge, in a portion of the gaseous medium located between E and E′1 called the first discharge area Z1 on the one hand, and in a portion between E and E′2, called the second discharge area Z2, on the other hand.

The cavity and the distribution of the electrodes are such that there is a plane of symmetry xz perpendicular to the plane of the cavity and passing through the electrode of the first type E, for the reasons explained above. Let x be the axis of this plane lying in the plane of the cavity.

The gyrolaser according to the invention comprises a conductive element 60 placed at a precise point around the path of the plasma discharges.

The conductive ignition element 60 is set at a predetermined potential, and its shape and arrangement are such that the symmetry with respect to the plane xz is maintained, as is that of the electric field generated by it. In the following text, the conductive ignition element is simply referred to as the conductive element.

If there is only one element, then for reasons of symmetry it is located on the axis x. In a variant, the conductive element is pad-shaped.

The method of guiding the charges at the moment of ignition is also shown in FIG. 3. The at least one conductive element 60 is adapted to generate locally an electric field which guides the charges at the moment of ignition, so that they are distributed symmetrically in a first flow F1 and a second flow F2 in the first discharge area Z1 and the second discharge area Z2 respectively. The symmetrical distribution of the charges on ignition thus enables ignition to be secured by initiating, on each occasion, a first plasma P1 in the first discharge area Z1 and a second plasma P2 in the second discharge area Z2.

The fine control of the electric field and of the corresponding field lines in the charge path in the discharge areas, that is to say along the path of the plasma discharges, enables the charges to be guided at the critical moment of ignition. During the ignition phase, the charges will follow the field lines and force the connection of the plasma to the correct electrodes.

The conductive element 60 is located in the proximity of an area where the presence of the charges is not desired, that is to say a portion of gas which is not a discharge area, this portion being called the discharge-free area. The conductive element 60 is adapted to cause the local electric field 61 generated by the conductive element 60 to operate by repulsion of the charges out of an area which is not a discharge area, thereby preventing them from penetrating into this discharge-free area and forcing them to be distributed in the two symmetrical flows F1 and F2. The conductive element generates a potential barrier for the charges which would, on ignition, tend to travel all the way round the gyrolaser, flowing between the first and second electrode of the second type without passing the electrode of the first type.

This method of guidance is particularly effective for avoiding the short-circuiting (bridging) of an electrode.

Preferably, the conductive element should not be positioned near the areas Z1 and Z2 in which the plasmas P1 and P2 are initiated.

To obtain this repulsion effect, the potential V of the conductive element is preferably greater than Va, the potential of the electrodes of the second type E′1 and E′2 (preferably anodes) and is preferably substantially equal to Vc, the potential of the electrode of the first type E (preferably a cathode).

According to one embodiment shown in FIG. 3, the conductive element 60 is electrically connected to an external potential.

According to another embodiment, the conductive element 60 is connected to the cathode C. The predetermined potential V is then equal to Vc.

An embodiment of the gyrolaser according to the invention further comprises at least one additional conductive ignition element, or two additional conductive elements CE′1 and CE′2 according to the variant of the invention shown in FIG. 4.

The at least one additional conductive ignition element is set at a predetermined potential, and its shape and arrangement are such that the symmetry with respect to the plane xz is maintained, as is that of the electric field generated by it.

In the following text, the additional conductive ignition element is simply referred to as the additional conductive element.

The at least one additional conductive element is adapted to generate locally an electric field 31 which guides the charges at the moment of ignition so that they are distributed symmetrically in a first flow F1 and a second flow F2 in the first discharge area Z1 and the second discharge area Z2 respectively. The symmetrical distribution of the charges on ignition thus enables ignition to be secured by initiating, on each occasion, a first plasma P1 in the first discharge area Z1 and a second plasma P2 in the second discharge area Z2.

The fine control of the electric field and of the corresponding field lines in the charge path in the discharge areas, that is to say along the path of the plasma discharges, enables the charges to be guided at the critical moment of ignition. During the ignition phase, the charges will follow the field lines and force the connection of the plasma to the correct electrodes. The additional conductive elements each comprise at least one part extending along the charge path in the discharge areas Z1 and Z2, that is to say along the path of the plasma discharges.

According to one embodiment shown in FIG. 4, two additional conductive elements CE′1 and CE′2 are placed in the proximity of the electrodes of the second type E′1 and E′2. The electric field created locally by the conductive elements, and the corresponding field lines, guide the electrons, which “return” through the electric field, that is to say follow it in the reverse direction, and attract them along the discharge areas Z1 and Z2. In fact, the electrons return through the electric field as far as the electrodes of the second type to establish the electrical connection. The guidance works by attracting the charges into a given region corresponding to the areas Z1 and Z2.

To maintain the symmetry of the system, CE′1 and CE′2 are set at an identical predetermined potential.

FIG. 4 shows the case in which two guidance modes, repulsion and attraction, are combined in a gyrolaser 30 according to the invention.

According to one embodiment shown in FIG. 4, at least one conductive element, including but not limited to the additional conductive elements, is strip-shaped.

According to one embodiment as shown in FIG. 4, the conductive elements CE′1 and CE′2 are connected to the electrodes of the second type E′1 and E′2, which are for example anodes at the potential Va. This type of connection has the advantage of being easy to provide in practice.

The predetermined potential V of the conductive elements is then equal to Va. Typically, a potential Va of −100 V to −300 V is applied to the anodes.

According to another embodiment, the conductive elements are connected to a predetermined external potential V, generated by an independent source, taken from the electronic circuits of the gyrolaser for example. Preferably, the potential V is greater than or equal to Va. This type of connection to an external source offers more room to manoeuvre in the control of the electric field.

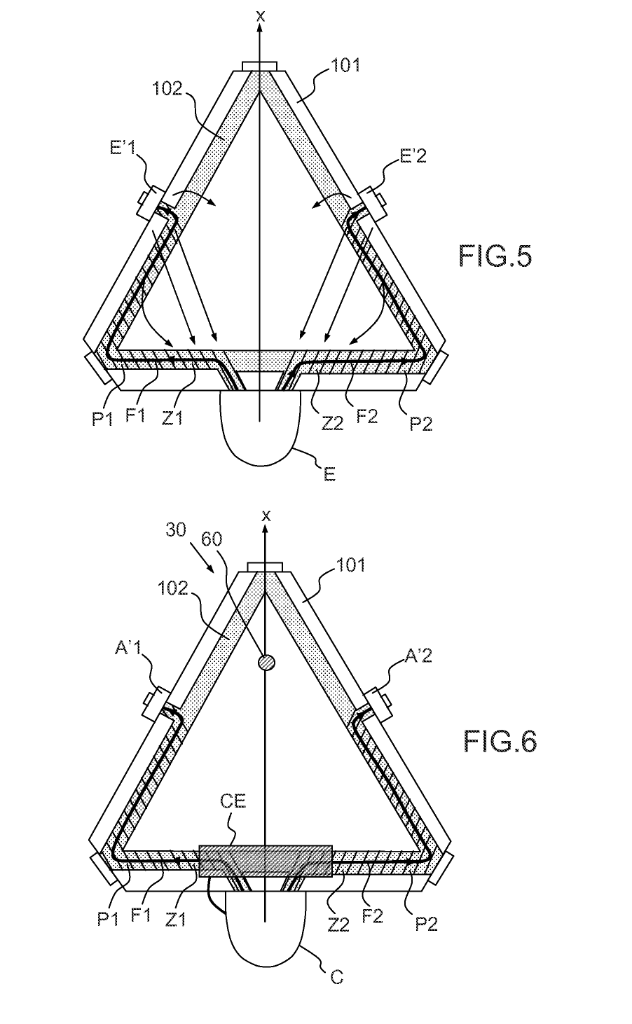

FIG. 5 shows, for comparison, the distribution of the electric field according to the prior art, without the conductive elements at a predetermined potential according to the invention.

FIG. 6 shows an embodiment of the invention comprising an additional conductive element CE, a part of which extends along the plasma discharge path, this element being located in the proximity of the electrode of the first type E, for example a cathode C. The additional element CE is, for example, in the shape of a strip placed along the charge path in the vicinity of the cathode, maintaining symmetry. The field lines generated by CE guide the charges in the vicinity of the cathode C so that they are distributed symmetrically in two flows F1 and F2.

Typically, a potential Vc of −500 V to −600 V is applied to the cathode. In FIG. 6, the additional conductive element CE is connected to the cathode at the potential Vc. The predetermined potential V of the conductive element is then equal to Vc.

According to another embodiment, the conductive element is connected to a predetermined external potential V, taken from the electronic circuits of the gyrolaser for example.

Preferably, the potential is lower than Vc and greater than Va, so that it never opposes the direction of flow of the charges.

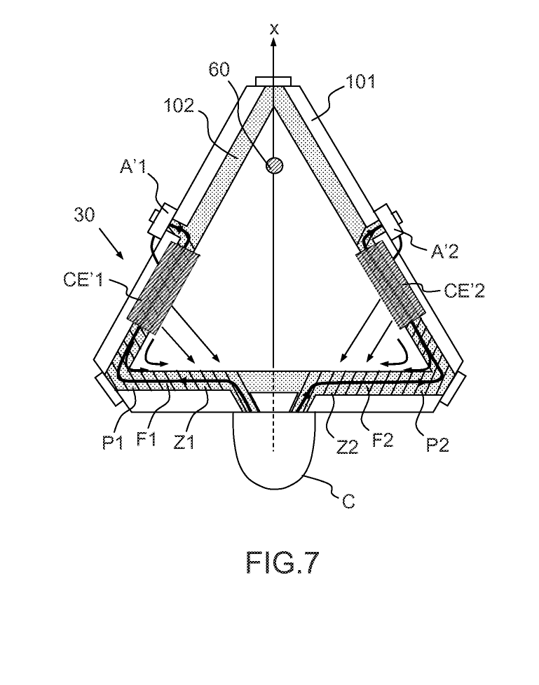

The gyrolaser shown in FIG. 7 comprises:
at least one conductive element 60 placed in the proximity of a discharge-free area and providing guidance by repulsion of charges out of an area which does not form a discharge area.
two additional conductive elements CE′1 and CE′2, comprising at least one part extending along the charge path in the plasma discharge areas Z1 and Z2, providing guidance by attracting the charges into these areas, and connected to the electrodes of the second type which are the anodes A′1 and A′2.

The conductive element may have any shape, and may also be composed of a plurality of parts, for example a conductive strip and a pad at its end.

According to one embodiment, the conductive element is placed on the surface of the block 101. For example, if the element is strip-shaped, it may be a strip of conductive adhesive tape bonded on to the surface. The metallic strips may also be deposited by lacquer deposition or by a vacuum deposition method. One advantage of vacuum deposition is that the metallic layers are uniform, providing greater assurance of symmetry of the electric fields.

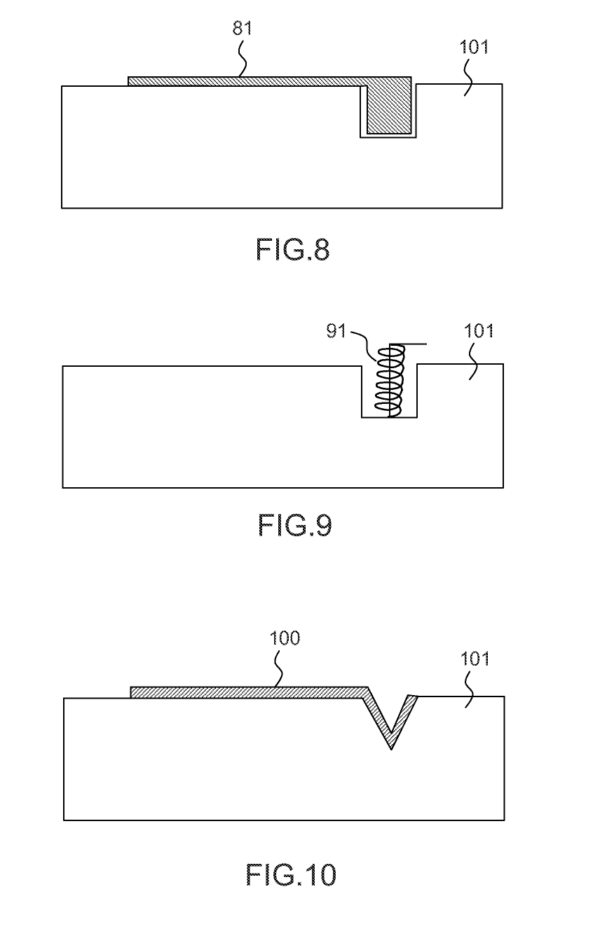

According to another embodiment shown in FIGS. 8 and 9, the conductive element 81 is placed at least partially within a cavity of the block 101.

This cavity may be formed by drilling, for example.

According to various non-limiting examples, the element 81 of FIG. 8 is pad-shaped, and the element 91 of FIG. 9 is spring-shaped.

According to another embodiment, the conductive element 100 may be a metallic layer deposited on to the surface of the block and inside a point-shaped cavity, as shown in FIG. 10. An advantage of this geometry is that the conductive element has a double function, namely that of generating a potential to guide the charges flowing in the amplification medium, and that of trapping the ions present in the block 101 by the point effect.

The gyrolaser according to the invention may be a single-axis gyrolaser, as shown in the preceding figures. In this case, the gyrolaser has an optical cavity and an electrode of a first type, and the plane of symmetry passes through the electrode of the first type.

The gyrolaser according to the invention may also be a three-axis gyrolaser. In this case, the gyrolaser has three optical cavities, each comprising a plane of symmetry. The three-axis gyrolaser, as a whole, comprises an axis of symmetry corresponding to the intersection of the three planes of symmetry of the three cavities.

1. A gyrolaser comprising:
at least one ring-shaped optical cavity and a gaseous medium, at least a portion of which forms an amplification medium, the cavity and the amplification medium being contained in a block and being such that two optical modes, called counter-rotating, can be propagated in opposite directions to each other within the optical cavity,
at least three electrodes in contact with the gas of the amplification medium, namely at least one electrode of a first type and at least a first electrode of a second type and a second electrode of a second type,
said electrodes being adapted to generate charges in a portion of gaseous medium located between said electrode of a first type and said first electrode of the second type, called the first discharge area, and in a portion of gas located between said electrode of a first type and said second electrode of the second type, called the second discharge area, when an electrical ignition voltage is applied, respectively, between said electrode of a first type and said first electrode of a second type, and between said electrode of a first type and said second electrode of the second type,
said cavity and a distribution of said electrodes comprising at least one plane of symmetry perpendicular to the plane of the cavity,
at least one conductive ignition element set at a predetermined potential, the shape and arrangement of which are such that said symmetry is maintained, and
said electrically conductive element being adapted to generate an electric field locally for guiding said charges so that they are distributed symmetrically in a first flow and a second flow in said first and second discharge areas respectively when said ignition voltage is applied, in such a way that a first plasma and a second plasma are initiated simultaneously, respectively, in said first discharge area and in said second discharge area, said electrically conductive element being placed in the proximity of a discharge-free area and providing guidance by repulsion of charges out of an area which does not form a discharge area.

2. The gyrolaser according to claim 1, further comprising an additional conductive element comprising at least one part extending along the path of said charges in said plasma discharge areas and providing guidance by attracting said charges into said areas.

3. The gyrolaser according to claim 1, wherein said electrode of the first type is a cathode and said electrodes of the second type are anodes.

4. The gyrolaser according to claim 1, wherein at least one conductive element is electrically connected to an electrode.

5. The gyrolaser according to claim 1, wherein at least one conductive element is strip-shaped.

6. The gyrolaser according to claim 1, wherein at least one conductive element is pad-shaped.

7. The gyrolaser according to claim 1, wherein at least one conductive element is placed on the surface of said block.

8. The gyrolaser according to claim 1, wherein at least one conductive element is placed at least partially within a cavity of said block.
